(19) United States
(12) Patent Application Publication
(10) Pub. No.: US 2021/0103418 A1
(43) Pub. Date: Apr. 8, 2021

(54) System And Method For Transforming Static Displays To Interactive Spaces

(71) Applicant: Argineering, Inc., Newark, DE (US)

(72) Inventor: David Erian, Cairo (EG)

(73) Assignee: Argineering, Inc., Newark, DE (US)

(21) Appl. No.: 16/936,430

(22) Filed: Jul. 23, 2020

Related U.S. Application Data
(60) Provisional application No. 62/888,108, filed on Aug. 16, 2019.

(51) Int. Cl. G06F 3/14; G06F 3/01

(52) U.S. Cl. CPC G06F 3/14; H04W 88/08; G06F 3/01

(57) ABSTRACT

A method and a system that turns static displays, exhibits and designs into interactive spaces is disclosed. The system consists of a set of plug-and-play modules, an intuitive application (app) and supporting accessories which allow exhibit creators to make exhibit designs with ease and interact with their audience.

### PRIORITY CLAIM

This patent application claims the benefit of priority, under 35 U.S.C. Section 119(e) to U.S. Provisional Application Ser. No. 62/888,018, entitled “System and Method for Converting Static Displays to Interactive Spaces” filed on 16 Aug. 2019, to David Erian which is hereby incorporated by reference in its entirety.

### BACKGROUND

Disclosed herein are methods and systems for providing collaborative viewing, and more particularly to convert a media presentation, such as a static exhibit, display or design into an interactive experience.

In some applications, such as point-of-sale, retail, visual merchandising, on-ground activations, events, museums and the like, it is desirable to provide an interactive interface for displaying information to a user. This interactivity provides a more engaging medium for presenting information (e.g., physical designs, lights, audio, digital media and the like). By engaging the attention of a person, for even a few moments, and making them part of an experience, the person may be more likely to absorb the information presented in the interactive display than in previous displays, as well as retain this experience as a memorable and enjoyable one.

In retail stores, art installations, exhibitions, museums and the like, it is difficult to offer physical interactive displays because they require initial programming. A significant drawback of the above interactive multimedia, especially those that require programming, is its difficulty and expensiveness. Therefore, there is a need in the creative industry for a tool with components that can associate with an exhibit/presentation and does not require programming while maintaining affordability.

### SUMMARY

According to aspects of the embodiments, there is a provided method and system that turns static displays, exhibits and designs into interactive spaces. The system consists of a set of plug-and-play modules, an intuitive application (app) and supporting accessories which allow exhibit creators to make designs interact with their audience with ease. It combines physical Interactions with sensors, motors and software for the desired outcome of easily created and customizable interactive experiences, without the necessity of relying on programming or hiring an engineer.

### BRIEF DESCRIPTION OF THE DRAWINGS

FIG. 1 depicts an exemplary diagram of a network of modules (NOM) for an interactive display capable of being programmed by external device in accordance to an embodiment;

FIG. 2 shows an interactive display with a control unit and components for exchanging user interactions in accordance to an embodiment;

FIG. 3 illustrates a block diagram of a control unit with a processor for executing instructions to automatically control the interactive display of FIG. 1 and FIG. 2 in accordance to an embodiment;

FIGS. 4A and 4B illustrate a tool interface of RGKit App for planning an interactive project, setting parameters, and conditions that when compiled by a control unit creates an interactive experience in accordance to an embodiment;

FIGS. 5A and 5B illustrate a flowchart of a method to create a project and to run the project in accordance to an embodiment;

FIGS. 6A and 6B illustrate a flowchart of a method for initializing the control unit, components of the presentation, and computer hosting the tool in accordance to an embodiment; and

FIG. 7 is a flowchart of a method to deliver an interactive exhibit/display in accordance to an embodiment.

### DETAILED DESCRIPTION

Aspects of the embodiments disclosed herein relate to methods and systems to create interactive displays in many places like storefront windows, events, booths, activations, museums, exhibitions, installations, and the like.

The disclosed embodiments include a method performed by a control unit (CU) to deliver an interactive display to a user, the method comprising receiving from an external device at least one process with parameters for controlling and for setting conditions and actions at the interactive display; wherein the at least one process relates to at least one module at the interactive display; and triggering a control sequence responsive to a predetermined triggering event; wherein the triggering event is generated by at least one module at the interactive display.

The disclosed embodiments further include a system to create interactive displays comprising a processor; and a storage device coupled to the processor, wherein the memory comprises instructions which, when executed by the processor, cause the processor to deliver an interactive display to a user: receiving from an external device at least one process with parameters for controlling and for setting conditions and actions at the interactive display; wherein at least one process relates to at least one module at the interactive display; and triggering a control sequence responsive to a predetermined triggering event; wherein the triggering event is generated by the at least one module at the interactive display.

The disclosed embodiments further include a non-transitory computer readable medium having executable instructions recorded thereon that, when executed by a processor, cause the processor to execute steps of a method to deliver an interactive display to a user: using a generated wireless access point (WAP) base station maintained by an external control unit (CU) that manages one or more modules at the interactive display; wherein the one or more modules are selected from a group consisting of at least one feel module and/or at least one animate module; uploading a project to the CU with at least one process with parameters for controlling and for setting conditions and actions for the one or more modules at the interactive display; and generating a start command to begin interacting by the user as one of the actions using the uploaded project.

The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth herein.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Although embodiments of the invention are not limited in this regard, discussions utilizing terms such as, for example, “processing,” “computing,” “calculating,” “determining,” “applying,” “receiving,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of resistors” may include two or more resistors.

As used herein, the term “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

Embodiments as disclosed herein may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device like a processor to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein.

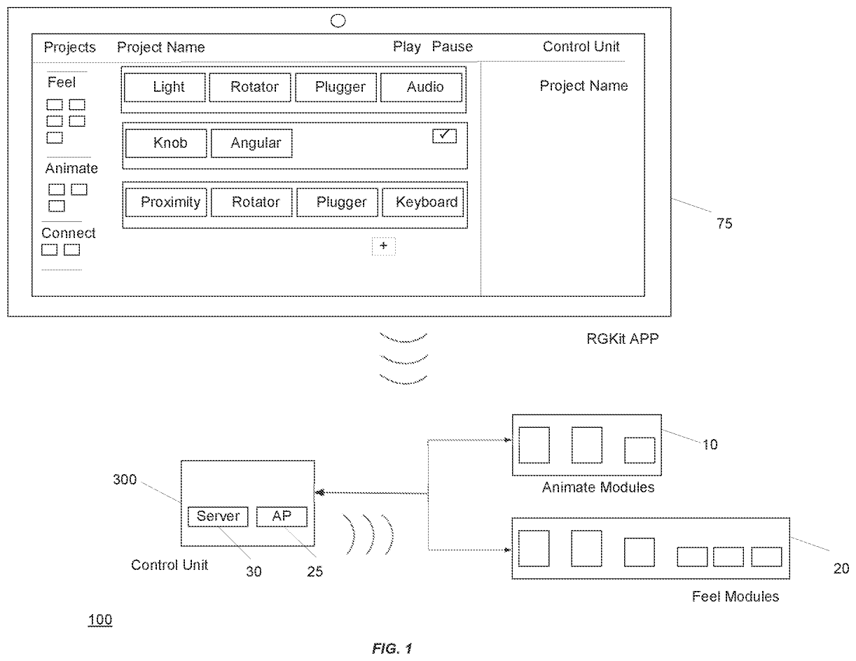

FIG. 1 depicts an exemplary diagram of a network of modules (NOM) for an interactive display capable of being programmed by an external device in accordance to an embodiment. A network is arranged so the master control unit (CU) 300 and the slave devices, such as animate 10 and feel 20 modules, communicate as a wireless network based on an Ethernet protocol. According to an embodiment the control unit (CU) 300 is configured to transmit and receive information in both direction of the network of slave devices 10 and 20. Bidirectional communication insures that the network maintains some level of redundancy. Additionally, network 100 can be separated into at least two channels to avoid collisions within the switching fabric and the potential of dropping request packets when the modules communicate with each other. The two channels are separate physically and logically. The network 100 comprises control unit 300, feel modules 20, animate modules 10 all wirelessly connected through each other by a wireless service such as AP 25 provided by control unit 300 using an internal wireless cards capable of providing Wifi or Bluetooth communication.

Some of the modules 10, 20 in NOM 100 can be mobile within the geographic space, while others can be fixed to a particular location. The modules like module 20 and modules 10 can communicate among each other wirelessly as implemented by the control unit 300 or with wired interfaces such as an Ethernet port and the like. Accordingly, signals exchanged between the modules like module 10 can be for example electrical, electromagnetic, optical, or acoustic signals.

The animate modules 10 comprise actuators that control different types of movement as instructed by internal instructions or by implementation of control sequences received from the control unit 300. The animate modules consist of rotator, angular, and plugger modules.

The feel modules 20 comprise sensors that detect changes in their surrounding environment and generate a triggering signal or triggering event that when received by the control unit 300 causes it to generate a control sequence which is mainly directed at the animate modules 10. The feel modules comprise components such as proximity, touch, light, tilt, knob, and button modules.

The control unit 300 connects all the modules to each other and to RGKit App (Application) as implemented by a remote device such as laptop 75. The CU 300 acts as a connection transmission control protocol (TCP) server 30 on which all the modules and RGKit App can connect. There are two (2) servers at server 30 running inside CU 300 an HTTP server to serve HTTP requests and a WebSocket server to serve the data flow on the network.

Laptop 75 is an external device that connects to control unit 300 to ascertain the animate modules 10 and feel modules 20 that are associated with a particular network of modules like NOM 100 that can be combined to provide an interactive display.

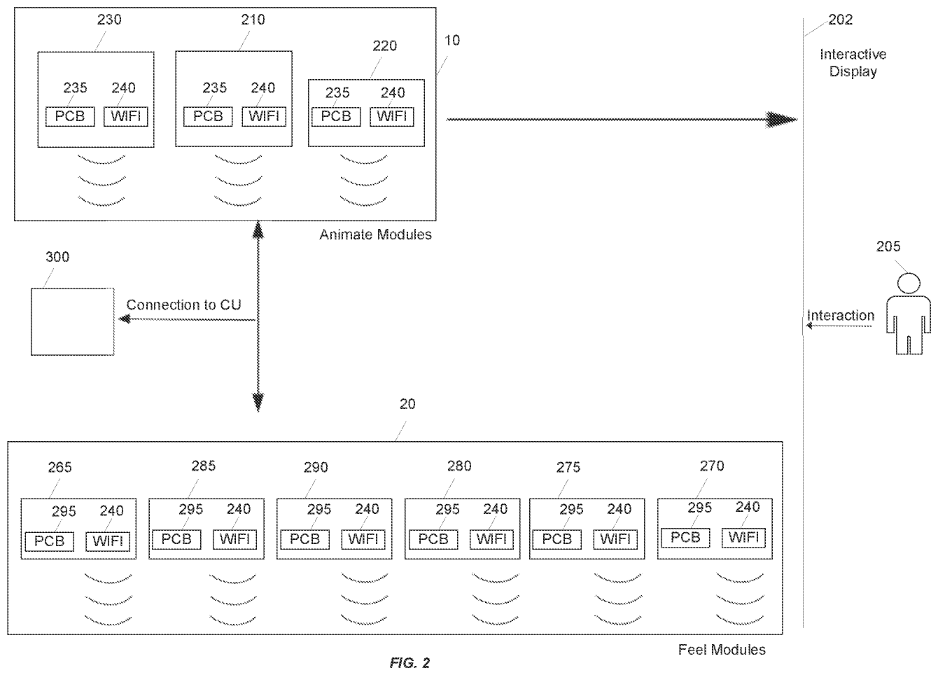

FIG. 2 shows an interactive display with a control unit and components for exchanging user interactions in accordance to an embodiment. Note that portions which are the same are denoted by the same reference numerals, and descriptions of the same portions as those as in FIG. 1 or within FIG. 2 will be omitted.

As the user 205 interacts with an interactive display 202, sensors, in the feel modules 20, detect changes in the surrounding environment so as to generate a triggering signal. For example, proximity module 265 could be set to trigger when the user is within a certain range of the interactive display 202.

Feel modules 20 consist of proximity module 265, touch module 270, light module 275, tilt module 280, knob module 285, button module 290, PCB module 295, and WiFi MCU module 240 which is equivalent to the same module used in animate modules 10.

The proximity module 265 is one of the feel modules 20, the proximity module 265 gets the value from an attached proximity sensor and sends it to the Control Unit 300 using WebSocket 370. The parameters for the proximity sensor can be set as a range between two values such as 17-110 cm.

The touch module 270 is one of the feel modules 20; it gets the value from an attached touchable magnet sensor and sends it to the CU 300 using WebSocket. The touchable magnet can detect if it is touched by a human body. In this module the Capacitance Sensing technology is used to detect human body touch. If a piece of metal is attached to the magnet, sensitivity of the sensor increases and therefore it can detect the proximity of a human body for up to 2 cm. The parameters for the touch module can be set as a range between 2 values between two numbers such as 0 to 100%.

The light module 275 is one of the feel modules 20; it gets the value from an attached light dependent resistor (LDR) sensor and sends it to the CU 300 using WebSocket. The parameter for the light module is set as a range between 2 values between two numbers such as 0 to 100%.

The tilt module 280 is one of the feel modules 20, this module detects the acceleration and the rotation in three (3) axes X, Y, Z. The tilt module 280 sends six (6) values such as X Acceleration, Y Acceleration, Z Acceleration, X Rotation, Y Rotation, and Z Rotation. Direction: this works for both types, however the values change. In case of Acceleration (negative values mean the opposite direction): X Axis (−100 to 100%), Y Axis (−100 to 100%), Z Axis (−100 to 100%), XYZ Axes (0 to 100%). In case of Rotation (negative values mean the opposite direction): Around X Axis (−180 to 180 degrees), and Around Y Axis (−180 to 180 degrees). The values are transferred to the CU 300 using WebSocket. The parameter for the tilt module is set as a range between two (2) values that change depending on the user's choice of type and direction.

The knob module 285 is one of the feel modules 20, it gets the value from an attached potentiometer and sends it to the control unit 300 using WebSocket. The parameter for the knob module 285 is set as a range between 2 values between two numbers such as 0 to 100%.

The button module 290 is one of the feel modules 20, it gets the value from the attached push button and sends it to the control unit using 300 WebSocket. The button has two (2) values. On press: triggered when pressed, and on release: triggered when released.

The printed circuit board (PCB) such as PCB 235 and PCB 295 provide power to the modules and link the electronic components together. WIFI MCU 240 as shown at animate modules 10 and feel modules 20 is a WiFi micro controller chip which controls the module and provides WiFi connection to the control unit 300 and other WiFi enabled devices.

The feel 20 and animate 10 modules are playing the role of clients in a client-server architecture 100. When these modules are plugged to their corresponding power sources for the first time, each module will try to connect to the nearest CU 300 network. It is doing this action by checking the strength of the received signal strength indicator (RSSI) of each network 100, 200. When the module is connected to the CU's network, it saves this CU 300 on the micro controller's memory so that the next time it runs, it will connect automatically to it no matter how many CUs are nearby.

The animate modules 10 has actuators that control different types of movement. The animate modules 10 consist of rotator module 210, angular module 220, and plugger module 230.

The rotator module 210, consists of a motor that creates a 360 degrees rotation in two (2) directions (clockwise and anti-clockwise) with different speeds. It is one of the animate modules 10, it waits for the command to be sent by the control unit 300 to take action. Speed: a value from 0 to 125 RPM, Direction: clockwise or anti-clockwise; Start Condition: the starting condition of the module, Once Triggered: means once the conditions set in the Feel Module are met in the process, the motor will rotate for a certain amount of time set in the duration option, While Triggered: means as long as the conditions are met in the Feel Modules, Rotator will keep running and if the conditions are no longer met, it stops; End Condition: Timed: the duration of seconds during which the motor will run and then stop, Hold: the motor will start and hold its speed, Random: the duration of seconds the motor will run and then stop, however in a random duration. There are 2 values between which the random duration shall be. This random duration is generated by the CU, based on the two values set by the user. Acceleration: Constant: runs in a constant speed from start to end, Ease In: starts in a slow speed until it reaches the required speed, Ease Out: starts at the required speed and ends with a slow speed in an easing motion, Ease In Out: starts at a slow speed until it reaches the required speed and ends at a slow speed, Accelerate: during the time set in the duration, it starts at 0 R/M and ends at the desired speed, Decelerate: during the time set in the duration, it starts at the desired speed and ends at 0 R/M; Safe Margin: this is used if the Start Condition is set to while triggered, is the number of seconds Rotator continues moving even after the feel module stopped being triggered, if the feel module is triggered again during the set duration the Rotator will continue moving, it the feel module is not triggered again during the set duration the Rotator will stop moving.

This angular module 220 consists of a motor that can move from 0 degrees to 180 degrees. The module uses a servo motor which is a rotary actuator that allows for precise control of angular position, velocity and acceleration. The servo motor consists of a DC motor coupled with a sensor for position feedback. It is one of the animate modules 10, it waits for the command to be sent by the control unit 300 to take action. It consists of rotation in a range of 0-180 degrees at a speed value from 0 to 60 half RPM; Start Condition: the starting condition of the module, Once Triggered: means once the conditions are met in the process it will run for a certain number of half revolutions between the start and end angles, While Triggered: means as long as the conditions are met in the Feel Modules, Angular will keep running and if the conditions are no longer met, it stops; End Condition: Ping-Pong: meaning that Angular will move back and forth between the start and end angle, Hold: meaning it will go from the start angle and stop at the end angle, Ping-Pong delay: in case the End Condition is “Ping-Pong” this option is used, Ping delay: the delay in the start angle, Pong delay: the delay in the end angle; 8No. of Half Revolutions: this is used if the Start Condition is set to once triggered, it is the number of times Angular will go back and forth between the angles (start and end); Safe Margin: this is used if the Start Condition is set to while triggered, is the number of seconds Angular continues moving even after the feel module stopped being triggered, if the feel module is triggered again during the set duration the Angular will continue moving, it the feel module is not triggered again during the set duration the Angular will stop moving.

Plugger module 230 is one of the animate modules 10, it waits for the command to be sent by the control unit 300 to take action. It controls the intensity of AC Electricity, such as the intensity of a light bulb. Range: The start and end range of electrical intensity. For example, if the main electricity is 220 Volts then 0% is 0 volts and 100% is 220 Volts. It supports both 220 Volts and 110 Volts. Type: Dimming: going smoothly between the start and end range, Sharp: going directly from start to end in one step; Dimming Duration: the time it takes to go from the start to the end range, Start Condition: the starting condition of the module, Once Triggered: means once the conditions are met in the process it will run for a certain number of times set in the No. of Blinks, While Triggered: means as long as the conditions are met in the feel modules, the Plugger will keep running and if the conditions are no longer met, it stops; End Condition: Ping-Pong: meaning that Plugger will bounce back and forth between the start and end range, Hold: meaning it will go from the start intensity and stop at the end intensity, Dim-Bright Duration: in case the End Condition is “Blink” this option is used, Dim Duration: the duration at the start intensity, Bright duration: the duration at the end intensity; No. of Blinks: this is used if the Start Condition is set to Once Triggered, it means how many times Plugger will go back and forth between the intensity ranges (start and end); Safe Margin: this is used if the Start Condition is set to while triggered, is the number of seconds Plugger continues running even after the feel module stopped being triggered, if the feel module is triggered again during the set duration the Plugger will continue running, it the feel module is not triggered again during the set duration the Plugger will stop moving.

Interactive display 202 is a representation that combines the feel modules 20 and animate modules 10 so that the user 205 can trigger and/or enjoy a dynamic experience consisting of sequenced physical movements generated by the animate modules or stored content such as audio and video generated by connect modules. The audio and video content is a set of individual multimedia files including video, audio, still images, animation, text, HTML, syndicated content and combinations (MPEG, JPEG, Windows Media Format (WMV), QuickTime, GIF, DiVX, VOB, Macromedia Flash, RSS, HTML, and the like) compiled into a playlist.

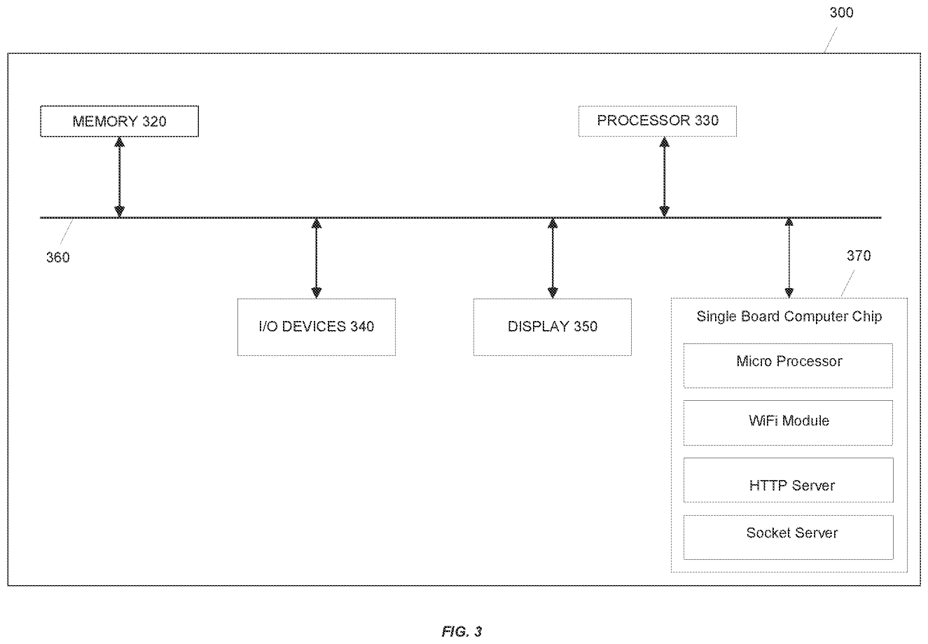

FIG. 3 illustrates a block diagram of a control unit 300 with a processor for executing instructions to autmatically control the interactive display of FIG. 1 and FIG. 2 in accordance to an embodiment.

The control unit 300 may be embodied within devices such as a desktop computer, a laptop computer like laptop 75, a handheld computer, an embedded processor, a handheld communication device, or another type of computing device, or the like. The control unit 300 may include a memory 320, a processor 330, input/output devices 340, a display 350 and a bus 360. The control unit performs services to enable communication from external devices and components of the interactive display. The services include generating a wireless access point (WAP) base station to manage communication with the control unit, components, external device. This communication can conducted through services such as socket and http services.

The bus 360 may permit communication and transfer of signals among the components of the control unit 300 or computing device. Bus 360 host may be a controller for a USB port, SDIO port, a PCI bus, or similar bus or connector.

Processor 330 may include at least one conventional processor or microprocessor that interprets and executes instructions. The processor 330 may be a general purpose processor or a special purpose integrated circuit, such as an ASIC, and may include more than one processor section. Additionally, the control unit 300 may include a plurality of processors 330.

Memory 320 may be a random access memory (RAM) or another type of dynamic storage device that stores information and instructions for execution by processor 330. Memory 320 may also include a read-only memory (ROM) which may include a conventional ROM device or another type of static storage device that stores static information and instructions for processor 330. The memory 320 may be any memory device that stores data for use by control unit 300. In the preferred embodiment, memory 320 is an internal secure digital (SD) card with capacities up to 16 GB.

Input/output devices 340 (I/O devices) may include one or more conventional input mechanisms that permit data between component of apparatus 100 and for a user to input information to the control unit 300, such as a microphone, touchpad, keypad, keyboard, mouse, pen, stylus, voice recognition device, buttons, and the like, and output mechanisms for generating commands to initiate powering of actuators, motors and the like, or may provide information to a user such as one or more conventional mechanisms that outputs information to the user, including a display, one or more speakers, a storage medium, such as a memory, magnetic or optical disk, disk drive, a printer device, and the like, and/or interfaces for the above. In some cases, through I/O 340, the user at PC 75 can implement a connect module causing CU 300 to serve or play audio files through a sound system. The display 350 may typically be an LCD or CRT display as used on many conventional computing devices, or any other type of display device.

The control unit 300 may perform functions in response to processor 330 by executing sequences of instructions or instruction sets contained in a computer-readable medium with readable program code, such as, for example, memory 320. Such instructions may be read into memory 320 from another computer-readable medium, such as a storage device, or from a separate device via a communication interface, or may be downloaded from an external source such as the Internet. The control unit 300 may be a stand-alone controller, such as a personal computer, or may be connected to a network such as an intranet, the Internet, and the like. Other elements may be included with the control unit 300 as needed.

Computer readable program code for carrying out operations for aspects of the present invention may be written in any combination of one or more programming languages, including an object oriented programming language such as Java, Smalltalk, C++ or the like and conventional procedural programming languages, such as the “C” programming language or similar programming languages like Perl, JavaScript (Node JS), or Python. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The memory 320 may store instructions that may be executed by the processor to perform various functions. For example, the memory may store instructions to control modules, listen for triggering events, to respond to triggering events, and to create an access point for enabling wireless communication. Importantly, memory 320 stores instructions to control the feel and animate modules based on a predetermined triggering event from the modules.

Memory 320 additionally contains instructions in single board computer chip 370 for performing services such as processing of data to orchestrate the interactive display, WiFi module for performing access point communication services, maintain an http server, and maintaining socket server.

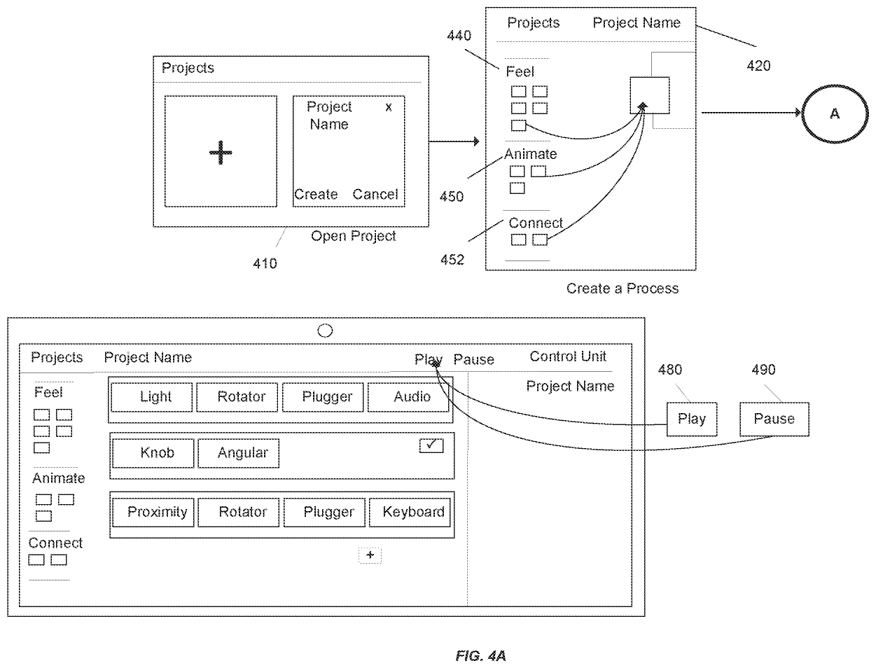

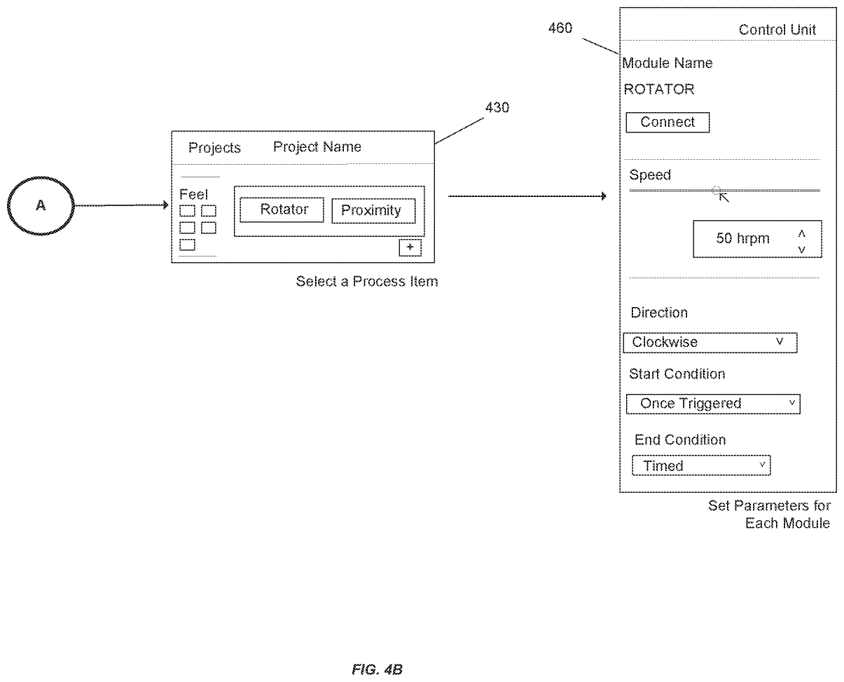

FIGS. 4A and 4B show a tool interface for planning an interactive project, setting parameters, and conditions that when compiled by a control unit creates an interactive experience in accordance to an embodiment. Before the user engages the nearest network of modules (NOM) the control unit 300 and modules associate with each other by creating master-slave cluster. This association will be visible to the user and the user can choose to include and parameterize the modules for a desired interactive display. Since the feel 20 and animate 10 modules are playing the role of clients in a client-server architecture. When these modules are plugged to their corresponding power sources for the first time, each module will try to connect to the nearest CU network. It is doing this action by checking the strength of the RSSI of each network. When the module is connected to the CU's network, it remembers this CU locally so that the next time it runs, it will connect automatically to it no matter how many CUs are nearby.

In this illustration the user who wants to create an interactive display would use laptop 75 or any other suitable computer with WiFi connection to open RGKit App. Projects can be created on the RGKit App in order to create different customized types of animations. Once the RGKIT App is open, the user can open a project 410 (FIG. 4A) and then create one or more processes 420, each process can contain one or many process items (feel or animate modules). The RGKit App is a tool that helps sequencing and controlling the modules' actions. A project can contain 1 or many processes 420 for parallel actions.

Returning to FIG. 4A, the user at computer interface 75 can select an individual process item that is related to a feel 440 or an animate 450 module. In some cases, the PC 75 running the RGKit App and the CU 300 itself are considered outputs and these kind of outputs are called Connect Modules. Connect Modules 452 give the user the possibility to do the following: (a) play audio files either from the PC 75 or the CU 300; (b) control the keyboard of the PC 75 running the RGKit app as if someone is typing or using it when it is required during an interaction. After a process item is selected parameters can be set for the process for controlling and for setting conditions and actions at the interactive display. At the set parameters for each module 460 (FIG. 4B) or process parameters the user can set the triggers and actions for a selected set of modules. The process item parameters are the parameters of each module 440 & 450, it can be considered as triggers if the parameters are set to feel modules 440, and can be considered as actions if the parameters are set to animate modules 450.

As an illustration a user would press play 480 to run the project, such as cause a rotation to take place, when someone approaches the exhibit. The user will connect the personal computer (PC) or laptop 75 running the RGKit App to the same Control Unit's WiFi network and open RGKit App. Once opened the user will create a project and will start by dragging a proximity process item in to an empty process at create a process 420. Then the user will drag a rotator process item into the same process. When the process contains one feel module 440 then this process is based on a condition/trigger, which is the value of the feel module 440. The user will click on the proximity icon, in order to set its parameters. First, the proximity must be linked to the process item using the connect button. Second, the user will set the range of the proximity between 20 and 60 cm for example. The user will click on the rotator icon, in order to set its parameters. Speed: 80 rpm; Duration: 10 seconds; Direction: clockwise. In this project, the user has set that rotator to start rotating in case there is an object/person in front of Proximity in the range of 20 to 60 cm. After the project has been opened and process have been selected with appropriate parameters the project can be activated. After setting the parameters the user will click the play button 480. Then the project will run and when someone is in front of proximity sensor, within the range of 20 to 60 cm, rotator will start moving for the duration of 10 seconds and when it is done the process will repeat itself and the proximity will again detect if someone is nearby.

When the user clicks the stop button 490 the control unit 300 will halt all the actions taken by the animate modules 10 and will stop the project from running. However, the project will be saved on the CU 300, this means that if the user turned off the PC 75 running the app and pushed the play button 480 the CU 300 will start running the project again. Using button 490 the user can stop the project.

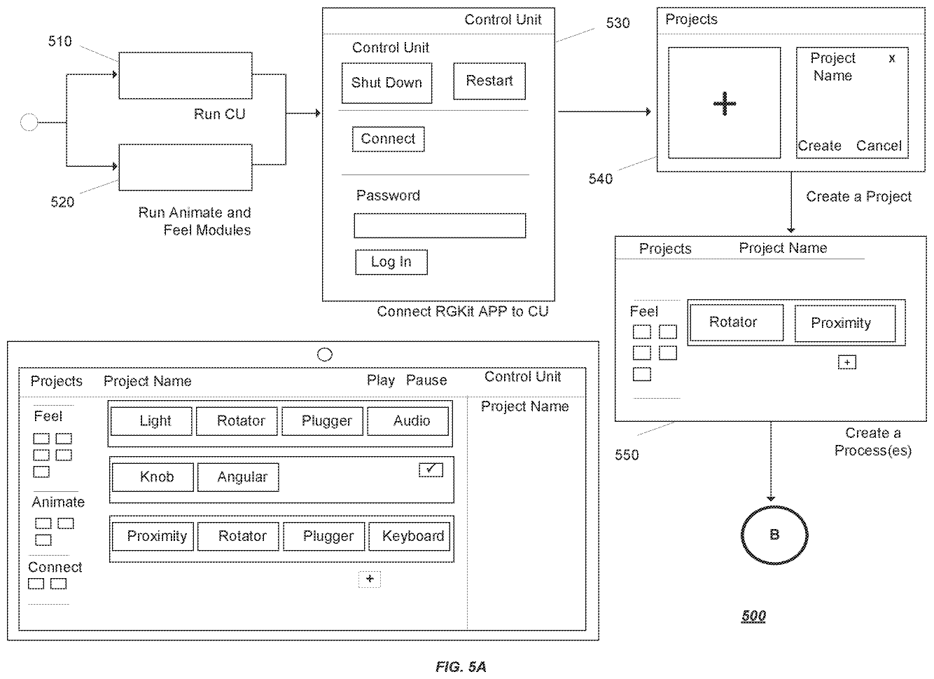

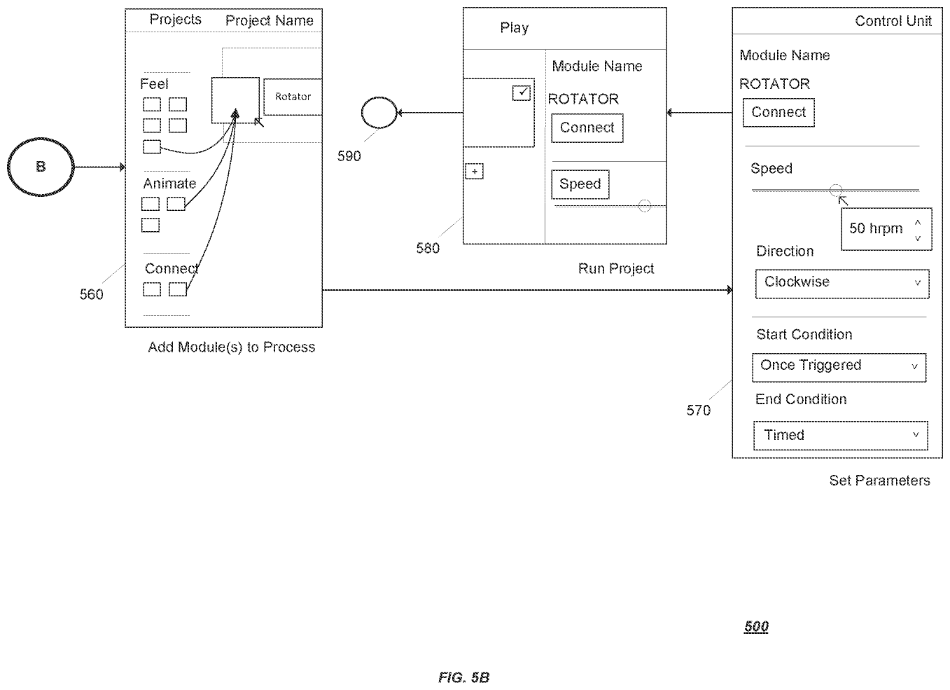

FIGS. 5A and 5B illustrate a flowchart of a method to create a project and to run the project in accordance to an embodiment. Process 500 begins by powering the control unit 300 and powering the animate 10 and feel 20 modules. In action 510 and 520 the modules are associated with the desired control unit 300 and the user is then able to create a project and set its parameters. In action 530 the user using the RGKit App connects to the control unit to create a project for an interactive display. In action 540 the user creates a project 540 like shown in FIGS. 4A and 4B. In action 550, the user creates a process using RGKit App. In action 560 (FIG. 5B), the user using the RGKit App can add modules to the process. In action, 570 the user using RGKit App can set parameters for the modules selected at action 560. In action 580, the user using RGKit App can run the project. Finally, the user can at any time choose to stop the project in action 590.

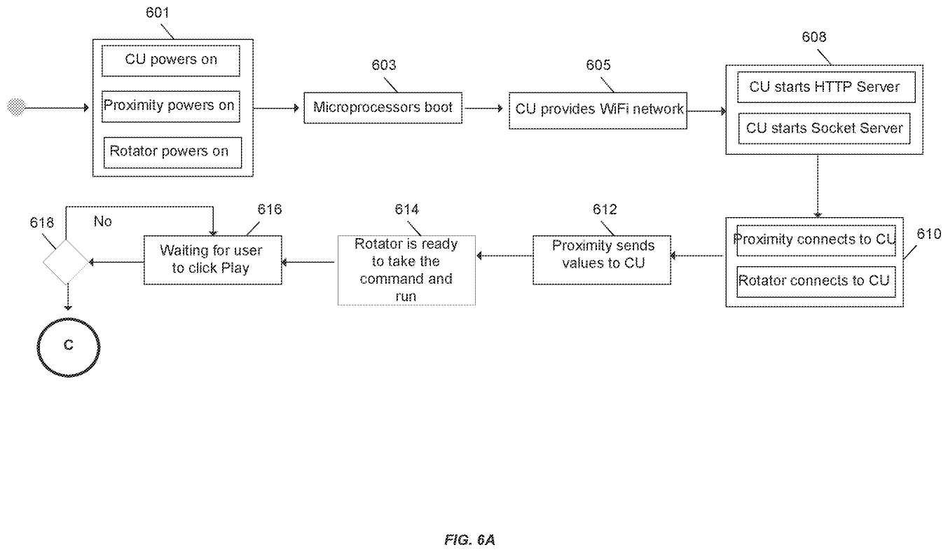

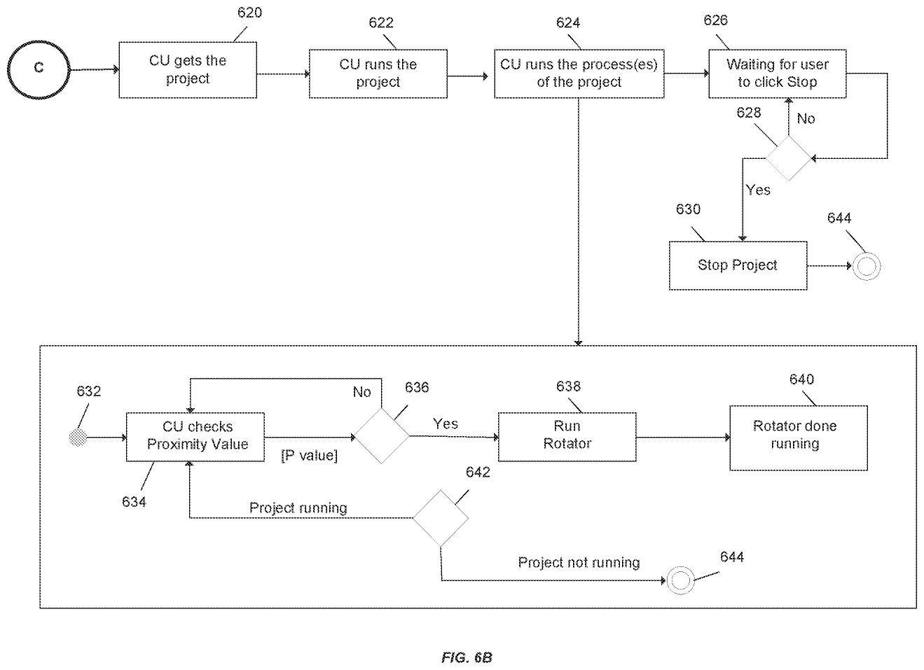

FIGS. 6A and 6B illustrate a flowchart of a method for initializing the control unit, components of the display, and computer hosting the tool in accordance to an embodiment. In FIGS. 6A and 6B, the illustrations explain what is happening in the backend of the interactive project using the proximity and rotator described above to show how the modules are working together. The process begins in action 601 by powering up the CU 300 and powering up the modules. In action 603, the microprocessors boot in the control unit 300 and modules. In action 605, the CU generates an AP to provide a WiFi network to associate the modules and the CU 300. The user uses RGKit App to connect to the CU to upload a project and to run a project. In action 608, the CU 300 starts the HTTP and socket server to enable a communication channel usable by the associated modules, CU, and external devices like PC 75 that waiting to exchange data, instructions, and information. In action 610, connection is established between the CU 300 and the modules such as animate 10 and feel 20 modules. In action 612, the proximity module sends values to the CU 300 that may or may not cause a triggering event. In action 614, the rotator is ready to take the command from CU 300 and run if it is so indicated. In action 616, the rotator is listening and waiting for the user to hit play at the RGKit App. In decision block 618, the process remains waiting (NO) or is passed to action 620 (FIG. 6B) for further processing. In action 620, a yes causes the CU 300 to receive the project from the user at PC 75. In action 622, the CU 300 runs the project and in action 624, the CU 300 runs the process of the project. In action 626, the CU 300 waits for the user at PC 75 to stop the project. At decision block 628 the system waits until the stop button is pressed before passing control to action 630 for stop project processing. If stop project has been initiated control is passed to action 644 which performs the stop action for the project. Returning to action 624 where the CU runs the process which commences when the user presses the play button 632 causing action 634 which causes the CU 300 to check the proximity value. Then the current reading of the proximity meets the parameters set in decision block 636, causes the rotator to run by action 638. Action 640 ascertains that the rotator is done running and transfers control to decision block 642. In decision block 642 the process checks if the project is running or not. If it is running then it checks Proximity value, if not then it stops. Decision block 642 checks the proximity value and runs the rotator when the conditions are met. This loop stops when the project is stopped at action 644.

Next, an embodiment of the present invention will be described. Note that portions which are the same as those in the first embodiment described above are denoted by the same reference numerals, and descriptions of the same portions as those as in the prior embodiments will be omitted.

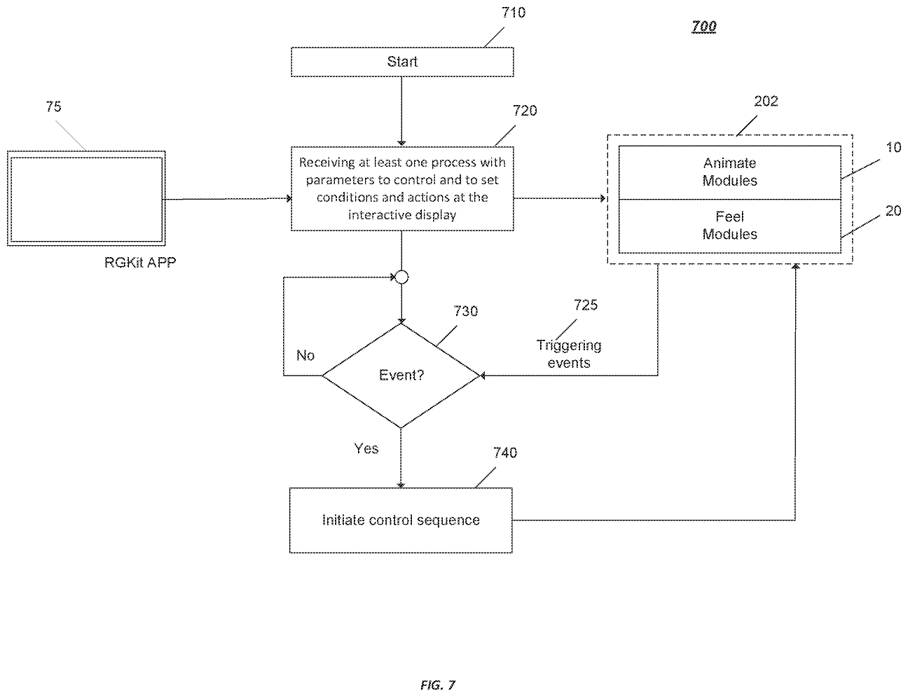

FIG. 7 is a flowchart of a method to deliver an interactive exhibit/display in accordance to an embodiment. Method 700 is a processes performed by a computing device such as controller 300.

Method 700 begins when controller 300 is initiated or when the start action 710 is invoked by a process from an internal or external source. Control is then passed to action 720 for further processing. Information from an external device such as computer 75 causes action 720 to receive at least one process with parameters to control and to set conditions and actions at the interactive display. From the information action 720 forwards the process parameters to modules 10 and 20 for processing and for establishing a relationship between the controller and the modules so that an interactive display can be created for the consumption of a user. In action 730, the method listens for a triggering event 725 before generating a control sequence. Upon the occurrence of a triggering event 725, as generated by the modules (feel 20 and animate), method 700 initiates a control sequence 740 that when compiled at the interactive exhibit 202 causes video, audio, and movement to be created therein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the claims that follow (after the Parts List and Functionality of Modules and Control Unit).

### Parts List and Functionality of Modules and Control Unit

### Background

The backend of RGKit is explained in a simple way in order to describe how it all works from a technical aspect.

### RGKit

RGKit is a design tool that turns static displays, exhibits and designs into interactive spaces. It consists of a set of plug-and-play modules, an intuitive app and supporting accessories which allow creatives to make their designs move, affordably and easily, and interact with their audience.

### Users

RGKit is made specifically for the creative industry, from designers to creative agencies to brands, to help them connect with their customers and tell their story. Interactive displays with mechanical movements have two main challenges; the technology is complicated and the cost is high. That's why brands and agencies are reluctant to integrate it within their displays. Despite the fact that it creates a more engaging experience and connects better with customers.

### Use Cases

It can be used to create interactive displays in many places like storefront windows, events, booths, activations, museums, exhibitions, installations . . . etc.

Components

RGKit Modules

Control Unit

Feel Modules

Animate Modules

Control Unit: Acts as the network router, so it creates the WiFi network required for the connection of the other system's items. The Control Unit creates a Server on which all the clients in the network are connected to.

Feel Modules and Animate Modules: Acts as clients in the network, they connect to the WiFi network provided by the Control Unit and search for the Control Unit in the network, in this case the Control Unit acts as the Server in a Client-Server architecture. They are considered Slaves of the Control Unit which acts as the Master.

RGKit Application: it connects to the Control Unit's network and is used as the programmer of the actions between the Control Unit and the Feel and Animate modules.

### RGKit Modules

This is considered the hardware part of RGKit. It consists of three main parts.

Feel Modules

Animate Modules

Control Unit

### Feel Modules

These are the sensors that detect changes in their surrounding environment.

### RGKit has 6 Feel Modules:

Proximity

Touch

Light

Tilt

Knob

Button

### Proximity

It detects if someone or something is nearby.

### Components

Sharp GP2Y0A02YK0F proximity sensor: it can detect objects between 15-150 cm

WiFi MCU: it is a WiFi micro controller chip which controls the module and provides WiFi connection

RGKit Proximity PCB: it provides the power to the module and link the electronic components together

### Touch

This module contains a touchable magnet which can detect if it is touched by a human body. In this module the Capacitance Sensing technology is used to detect human body touch. If a piece of metal is attached to the magnet, sensitivity of the sensor increases and therefore it can detect the proximity of a human body for up to 2 cm.

### Components

Magnet: it is connected to the module using a wire

WiFi MCU: it is a WiFi micro controller chip which controls the module and provides WiFi connection

RGKit Touch PCB: it provides the power to the module and links the electronic components together

### Light

This module detects light intensity in the surrounding environment

### Components

LDR Sensor: it is a component that has a variable resistance that changes with the light intensity that falls upon it

WiFi MCU: it is a WiFi micro controller chip which controls the module and provides WiFi connection

RGKit Light PCB: it provides the power to the module and links the electronic components together

### Tilt

This module detects the acceleration and the rotation in 3 axes X, Y, Z

### Components

GY-85 Sensor: This sensor contains multiple sensors

ADXL345: it provides 3 axis acceleration measurements

ITG3205: it provides 3 axis gyroscope measurements

HMC5883L: it provides 3 axis magnetic field measurements

WiFi MCU: it is a WiFi micro controller chip which controls the module and provides WiFi connection

RGKit Tilt PCB: it provides the power to the module and links the electronic components together

### Knob

This module consists of a knob that is detected when rotated

### Components

5K Potentiometer: it is a three-terminal resistor with a sliding or rotating contact that forms an adjustable voltage divider.

WiFi MCU: it is a WiFi micro controller chip which controls the module and provides WiFi connection

RGKit Knob PCB: it provides the power to the module and links the electronic components together

### Button

This module consists of a button that is detected when pressed or when released.

### Components

Button: it is a switch button that provides a reading when pressed

WiFi MCU: it is a WiFi micro controller chip which controls the module and provides WiFi connection

RGKit Button PCB: it provides the power to the module and links the electronic components together

### Animate Modules

These are the actuators that control different types of movement.

### RGKit has 3 Animate Modules

Rotator

Angular

Plugger

### Rotator

This module consists of a motor that creates a 360 degrees rotation in 2 directions (clockwise and anti-clockwise) with different speeds.

### Components

DC Motor: it is rotary electrical machines that converts direct current electrical energy into mechanical energy. It works under 12 VDC and has up to 130 RPM at free load. It can lift up to 20 kg/cm

WiFi MCU: it is a WiFi micro controller chip which controls the module and provide WiFi connection

RGKit Rotator PCB: it provides the power to the module and link the electronic components together

### Angular

This module consists of a motor that can move from 0 degrees to 180 degrees

### Components

Servo Motor: it is a rotary actuator that allows for precise control of angular position, velocity and acceleration. It consists of a suitable motor coupled to a sensor for position feedback.

WiFi MCU: it is a WiFi micro controller chip which controls the module and provides WiFi connection

RGKit Angular PCB: it provides the power to the module and links the electronic components together

### Plugger

This module contains a power socket through which it can control the AC electricity of many power operating devices for example, light bulbs (the intensity of light) and fans (the speed of rotation).

### Components

WiFi MCU: it is a WiFi micro controller chip which controls the module and provides WiFi connection

RGKit Plugger PCB: it provides the power to the module and links the electronic components together. This PCB contains a Dimmer Circuit to the current of the electricity.

### Control Unit

This is considered as the brain behind RGKit. It connects all the modules to each other and to RGKit App.

### Components

A Single Board Computer chip: it provides control and WiFi Connection

RGKit Control Unit PCB: it provides the power to the module and links the electronic components together

### RGKit App or APP

This is a desktop application that is responsible for the control and setting the conditions of the modules. Projects can be created on this application in order to create different customized types of animations

### Components

These are the main components on which a project relies.

Process: a process inside the application is a tool that helps sequencing and controlling the modules' actions. A project can contain 1 or many processes for parallel actions

Process Item: the process can contain one or many Process Items. The Process Item is related to a Feel or an Animate module.

Process Item Parameters: these are the parameters of each module, it can be considered as triggers if the parameters are set to feel modules, and can be considered as actions if the parameters are set to animate modules.

### Powering Up the Modules

The Feel and Animate modules are playing the role of clients in a client-server architecture. When these modules are plugged to their corresponding power sources for the first time, each module will try to connect to the nearest CU network. It is doing this action by checking the strength of the RSSI of each network.

When the module is connected to the CU's network, it remembers this CU locally so that the next time it runs, it will connect automatically to it no matter how many CUs are nearby.

### CU-Modules Connection

The connection between the CU and the modules is done using WiFi and it works as follows:

The CU provides a 2.4 GHz network which the modules support.

If the module is running for the first time:

Each module will scan the nearby WiFi networks

It will filter the ones that start with RGKit

It will sort these networks based on their RSSI (the strength of the signal) from the strongest to the weakest

It will pick the strongest one

Then the module will attempt to create a secured WiFi connection to this network

If successful it will save this network for future use

If not successful, it will restart and attempt to do all the previous steps

If the module had a previous CU connection:

It will retrieve the previous CU's network SSID (network name)

It will try to connect to this network if found

If not successful or not found, it will restart and attempt to do the previous steps

After the connection to the CU using WiFi:

Each module will try to get the IP address of the CU using a query sent over mDNS (which helps to resolve hostnames to IP addresses in a small network)

When retrieved, it will try to connect to the CU's HTTP server securely using HTTP requests

When the connection is successful, it will try to connect to the WebSocket server

When the connection is successful, the CU registers the connected modules in memory and the modules will keep the connection waiting for its commands from the CU

If any of the steps are failing the modules will restart

If any of the modules got disconnected for any reason, it will restart and attempt to do the previous steps

### RGKit App Connection to the CU

In order to control the CU, the user must use RGKit App. To use the app, the RGKit user will follow the below steps:

Download RGKit App from the developer of the tool.

Once downloaded, the user will install the RGKit App on their PC (Windows or MacOS)

The user will create a project (a project in the RGKit App is a file on the PC)

The PC must be connected to the network of the CU using the default password

Automatically the app will recognize the CU and will be connected to it using HTTP requests and WebSockets, in this case, the app is considered as a client as well as the modules

### CU I/O

The Control Unit is considered as RGKit's programmed maestro, so it takes inputs and based on many conditions, it produces actions that is translated into outputs (same as the Computer, the Keyboard is considered input and the Screen is considered output).

Input and outputs in the Control Unit are translated into Feel and Animate Modules. The Feel Modules are the inputs to the CU and the Animate Modules are the output of the Control Unit.

Based on the programming of the Project on RGKit App, the values of the Feel modules will influence the actions taken by the CU and translated into the Animate Modules. Each of the Feel modules has its own value and each of the Animate modules has its own actions.

In some cases, the PC running the RGKit App and the CU itself are considered outputs and these kind of outputs are called Connect Modules. Connect Modules give the user the possibility to do the following:

Play audio files either from the PC or the CU

Control the keyboard of the PC running the app as if someone is typing or using it

### Feel Modules Data-Flow

After the connection process, the Feel modules will serve to feed the CU with its readings, each one of the Feel modules has its own kind of reading. For each module, there is a sensor or a gadget that is translated into a human-readable value.

For each module, the data-flow between the module and the CU works as follows:

The module has established a secured and stable connection to the CU using the WebSocket server. As long as this connection is persistent and stable it will continue to the below steps

The MCU (Micro Control Unit) inside the module will take the value from the attached sensor.

The MCU will translate the value from binary format into a human readable format

The MCU will take this value and using the WiFi module will send this value over the network to the Control Unit

The MCU will remember the last sent value, and if the next reading is the same, the value will not be sent. If the value has changed, the MCU will send the value to the Control Unit

As the MCU running inside the module is single threaded, these steps will repeat endlessly as long as the connection is stable, otherwise it will restart and will attempt to the connect again.

### Animate Modules Listening

While the Feel Modules are sending the value to the CU, the Animate Modules are listening for the commands sent by the Control Unit. Each of the Animate Modules has an actuator. These actuators are either Motors or electricity controllers. Based on the commands sent by the CU, the Animate Modules will control its actuators.

For each Animate Module, the listening process works as follows

The module has established a secured and stable connection to the CU using the WebSocket server. As long as this connection is persistent and stable it will continue to the below steps

The MCU (Micro Control Unit) inside the module, will use the WiFi module attached to it in order listen to the CU's server using WebSockets

When the CU is ready to take an action, it will send a coded message to the module

The module will parse the message and will format it to the below format (an example is shown under the points)

Action Type: this represents the type or the state of the action

Action Parameters: this represents the parameters associated with the type of the action

Example for Rotator in which a motor represents the action:

Action Type: Run

Action Parameters:

Duration: 10 seconds

Speed: 80 R/M

Direction: clockwise

As the MCU running inside the module is single threaded, these steps will repeat endlessly as long as the connection is stable, otherwise it will restart and will attempt to connect again.

### RGKit App Project

The RGKit App Project consists of processes. Each Process in RGKit Project consists of both conditions and actions. The conditions are related to the Feel Modules and the actions are related to the Animate Module

RGKit project can contain multiple processes running simultaneously which gives the power of multi-processing inside the project.

The Process can contain multiple Process Items, each Process Item can be one of three types:

Feel: a Feel Module is attached to this Process Item, and this is where the conditions of the process are set. (For example, setting the value of Proximity between 30-50 cm, this means that when the current value is 40, the condition is met and the process will give the order to the Animate modules).

Animate: an Animate Module is attached to this Process Item and this is where the actions triggered in the process take place.

Connect: This also represents the action, however, these are actions taken by either the CU itself or the PC running RGKit App.

For any Process Item (Feel or Animate) to be active, it has to be linked to a physical connected module, if there are Process Items that are not connected, then the Project will not run.

If we have multiple Feel Process Items inside the single process, by default, the process will wait until all the conditions are met and then start running the Animate modules. This action can be changed by the process parameters inside the app and let the process run the Animate Modules if only one of the Feel conditions is met.

In some cases where there are no Feel Process Items inside the process and only Animate Process Items are present. The process will consider that there are no conditions and therefore, the Animate Modules will run based on their parameters.

By default, all the Animate and Connect Modules inside the process run at the same time. However in order to change this behavior, the user can set a delay value (in seconds) for each one of these modules.

The order of Animate Modules inside the process, can affect the sequence of the process. In the Animate and Connect Modules there is a sequencing option that allows the Animate and Connect Modules to run sequentially one after the other.

When all the Animate Modules are done running. The process will loop and do one of two things:

Run the Animate Modules if there are no Feel Modules

Wait until the conditions are met and then trigger the Animate Modules as programmed

### CU Reading the Project

When the user clicks the Play button the following happens

The RGKit project will be encoded and set in a format that is readable by the Control Unit.

The RGKit App will prepare the data that shall be sent to the Control Unit and this includes the project and if there are any files attached to the project like audio files.

When the preparation is done, the project data is sent using HTTP requests to the CU using the HTTP server

The CU gets the data and transforms it into objects readable by the CU

When the CU is done with preparing the data, the project will start running and the CU will have a running state

### CU Running the Project

When the project data is ready, the project will start running on the CU. The project items are translated into the below actions:

Each RGKit process is a thread inside the Control Unit's main process

Each Feel or Animate Process Item is a module connected to the CU

The values sent by the Feel Modules are the values that influence the conditions of the process (which are set by the Feel Process Items)

### CU Stopping the Project

When the user clicks the “Stop” button the Control Unit will halt all the actions taken by the Animate Modules and will stop the project from running. However, the project will be saved on the CU, this means that if the user turned off the PC running the app and pushed the play button on the CU, the project will start running again. Using this same button the user can stop the project.

### Modules in Action

This section will take about each module and how each one works

### Proximity

One of the Feel Modules, it gets the value from the attached Proximity sensor and sends it to the Control Unit using WebSocket.

### Parameters

Range: this value is set between 2 numbers (17-110 cm)

### Light

One of the Feel Modules, it gets the value from the attached LDR sensor and sends it to the Control Unit using WebSocket.

### Parameters

Intensity: this value is set between 2 numbers (0-100%)

### Knob

One of the Feel Modules, it gets the value from the attached Potentiometer and sends it to the Control Unit using WebSocket.

### Parameters

Percentage: this value is set between 2 numbers (0-100%)

### Touch

One of the Feel Modules, it gets the value from the attached Magnet (which is working as a touch sensor) and sends it to the Control Unit using WebSocket.

### Parameters

Sensitivity: this value is set between 2 numbers (0-100%)

### Button

One of the Feel Modules, it gets the value from the attached push button and sends it to the Control Unit using WebSocket.

### Parameters

Mode: which has 2 values:

On Press: triggered when pressed

On Release: triggered when released

### Tilt

One of the Feel Modules, it gets the values from the attached sensors and sends it to the Control Unit using WebSocket. This module sends 6 values:

X Acceleration

Y Acceleration

Z Acceleration

X Rotation

Y Rotation

Z Rotation

### Parameters

Type: it has 2 types

Acceleration

Rotation

Direction: this works for both types, however the values change:

In case of Acceleration (negative values mean the opposite direction):

X Axis (−100 to 100%)

Y Axis (−100 to 100%)

Z Axis (−100 to 100%)

XYZ Axes (0 to 100%)

In case of Rotation (negative values mean the opposite direction):

Around X Axis (−180 to 180 degrees)

Around Y Axis (−180 to 180 degrees)

### Angular

One of the Animate Modules, it waits for the command sent by the Control Unit. It consists of rotation in a range of 0-180 degrees.

### Parameters

Speed: a value from 0 to 60 half RIM

Angle: start and end angles from 0 to 180 degrees

Start Condition: the starting condition of the module

Once Triggered: means once the conditions are met in the process it will run for a certain number of half revolutions between the start and end angles

While Triggered: means as long as the conditions are met in the Feel Modules, Angular will keep running and if the conditions are no longer met, it stops.

End Condition:

Ping-Pong: meaning that the Angular will bounce back and forth between the start and end angles

Hold: meaning it will go from the start angle and stop at the end angle

Ping-Pong delay: in case the End Condition is “Ping-Pong” this option is used

Ping delay: the delay in the start angle

Pong delay: the delay in the end angle

No. of Half Revolutions: this is used if the Start Condition is set to once triggered, it is the number of times Angular will go back and forth between the angles (start and end)

Safe Margin: this is used if the Start Condition is set to while triggered, is the number of seconds Angular continues moving even after the feel module stopped being triggered, if the feel module is triggered again during the set duration the Angular will continue moving, it the feel module is not triggered again during the set duration the Angular will stop moving

### Rotator

One of the Animate Modules, it waits for the command sent by the Control Unit. It consists of rotation in 360 degrees.

### Parameters

Speed: a value from 0 to 125 R/M

Direction: clockwise or anti-clockwise

Start Condition: the starting condition of the module

Once Triggered: means once the conditions are met in the process will run for a certain number of seconds set in the duration option

While Triggered: means as long as the conditions are met in the Feel Modules, Rotator will keep running and if the conditions are no longer met, it stops

End Condition:

Timed: the duration of seconds the motor will run and then stop

Hold: the motor will start and hold its speed

Random: the duration of seconds the motor will run and then stop, however in a random duration. It takes 2 values between which the random duration shall be. This random duration is generated by the CU.

Acceleration: the type of acceleration

Constant: starts and ends at the same speed

Ease In: the motor starts slow for 2 seconds and ends in the desired speed

Ease Out: the motor starts at the desired speed and 2 seconds before the end it slows down

Ease Both: slowing the start and the end of the rotation

Accelerate: during the time set in the duration, it starts at 0 R/M and ends at the desired speed.

Decelerate: during the time set in the duration, it starts at the desired speed and ends at 0 R/M.

Safe Margin: this is used if the Start Condition is set to while triggered, is the number of seconds Rotator continues moving even after the feel module stopped being triggered, if the feel module is triggered again during the set duration the Rotator will continue moving, it the feel module is not triggered again during the set duration the Rotator will stop moving

### Plugger

One of the Animate Modules, it waits for the command sent by the Control Unit. It controls the intensity of AC Electricity.

### Parameters

Range: The start and end range of electrical intensity. For example, if the main electricity is 220 Volts then 0% is 0 volts and 100% is 220 Volts. It supports both 220 Volts and 110 Volts

Type:

Dimming: going smoothly between the start and end range

Sharp: going suddenly step for the start to end range

Dimming Duration: the time it takes to go from the start to the end range

Start Condition: the starting condition of the module

Once Triggered: means once the conditions are met in the process it will run for a certain number of times set in the No. of Revolutions

While Triggered: means as long as the conditions are met in the feel modules, the Plugger will keep running and if the conditions are no longer met, it stops.

End Condition:

Ping-Pong: meaning that Plugger will bounce back and forth between the start and end range

Hold: meaning it will go from the start intensity and stop at the end intensity

Dim-Bright Duration: in case the End Condition is “Blink” this option is used.

Dim Duration: the delay at the start intensity

Bright Duration: the delay at the end intensity

No. of Blinks: this is used if the Start Condition is set to Once Triggered, it means how many times Plugger will go back and forth between the intensity ranges (start and end)

Safe Margin: this is used if the Start Condition is set to while triggered, is the number of seconds Plugger continues running even after the feel module stopped being triggered, if the feel module is triggered again during the set duration the Plugger will continue running, it the feel module is not triggered again during the set duration the Plugger will stop running

### Audio

One of the Connect Modules, it helps in running an audio file either from the Control Unit or the PC running RGKit App.

### Parameters

Type: the audio file that will play from the CU or the PC

File: button to choose the audio file

Volume: the volume of the audio files played is set here

### Keyboard

One of the Connect Modules, it helps controlling the keyboard of the PC running RGKit App

### Parameters

Type:

Text: the keyboard will type the chosen text

Shortcut: the keyboard will execute a shortcut which is a combination of keys

End Condition:

Hold: means that when the conditions are met inside the process, the keyboard will execute the action and hold until the conditions are no longer met

Loop: means that when the conditions are met it will execute. As long as the conditions are met again, it will keep executing

Triggered Text: in case chosen type is Text, this will be the text written

Non-Triggered Text: in case chosen type is Text and End Condition is set to Hold, this will be the text written when the conditions in the process are not met

Triggered Shortcut: in case chosen type is Shortcut, this will be the shortcut executed

Non-Triggered Shortcut: in case chosen type is Shortcut and End Condition is set to Hold, this will be the shortcut executed when the conditions in the process are not met Animate-Connect Common Parameters

### These are Common Parameters Between the Animate and the Connect Modules

Synchronization:

With Previous: The module will start with the start of the previous module

After Previous: The module will start after the previous module has finished running

Delay: the duration of seconds the module will wait before it runs

What is claimed is:

1. A method performed by a control unit (CU) to deliver an interactive display to a user, the method comprising:
receiving from an external device at least one process with parameters for controlling and for setting conditions and actions at the interactive display;
wherein the at least one process relates to at least one module at the interactive display; and
triggering a control sequence responsive to a predetermined triggering event;
wherein the triggering event is generated by the at least one module at the interactive display.

2. The method in accordance to claim 1, further comprising:
generating wireless access point (WAP) base station to manage communication between the external device, the at least one module, and the control unit.

3. The method in accordance to claim 2, wherein the at least one module is selected from a group consisting of at least one feel module, at least one animate module, or combination thereof.

4. The method in accordance to claim 3, wherein the at least one feel module is selected from a group consisting of proximity module, touch module, light module, tilt module, knob module, and button module.

5. The method in accordance to claim 4, wherein the at least one animate module is selected from a group consisting of rotator module, angular module, and plugger module.

6. The method in accordance to claim 5, wherein the at least one module initiates a connection to the control unit based on a received signal strength indicator (RSSI).

7. The method in accordance to claim 5, wherein the CU takes inputs and based on the conditions the CU produces actions that are translated into outputs.

8. The method in accordance to claim 5, wherein the outputs from the CU when processed by the at least animate module causes the rotator module, the angular module, or the plugger module to perform a function at the interactive display.

9. A system to create an interactive display comprising:
a processor; and
a storage device coupled to the processor, wherein the memory comprises instructions which, when executed by the processor, cause the processor to deliver an interactive display to a user:
receiving from an external device at least one process with parameters for controlling and for setting conditions and actions at the interactive display;
wherein the at least one process relates to at least one module at the interactive display; and
triggering a control sequence responsive to a predetermined triggering event;
wherein the triggering event is generated by the at least one module at the interactive display.

10. The system in accordance to claim 9, the processor further performing:
generating wireless access point (WAP) base station to manage communication between the external device, the at least one module, and the control unit.

11. The system in accordance to claim 10, wherein the at least one module is selected from a group consisting of at least one feel module, at least one animate module, or combination thereof.

12. The system in accordance to claim 11, wherein the at least one feel module is selected from a group consisting of proximity module, touch module, light module, tilt module, knob module, and button module.

13. The system in accordance to claim 12, wherein the at least one animate module is selected from a group consisting of rotator module, angular module, and plugger module.

14. The system in accordance to claim 13, wherein the at least one module initiates a connection to the control unit based on a received signal strength indicator (RSSI).

15. The system in accordance to claim 13, wherein the CU takes inputs and based on the conditions the CU produces actions that are translated into outputs.

16. The system in accordance to claim 13, wherein the outputs from the CU when processed by the at least animate module causes the rotator module, the angular module, or the plugger module to perform a function at the interactive display.

17. A non-transitory computer readable medium having executable instructions recorded thereon that, when executed by a processor, cause the processor to execute steps of a method to deliver an interactive display to a user:
using a generated wireless access point (WAP) base station maintained by an external control unit (CU) that manages one or more modules at the interactive display;
wherein the one or more modules are selected from a group consisting of at least one feel module and/or at least one animate module;
uploading a project to the CU with at least one process with parameters for controlling and for setting conditions and actions for the one or more modules at the interactive display; and
generating a start command to begin interacting by the user as one of the actions using the uploaded project.

18. The non-transitory computer readable medium according to claim 17, wherein the at least one feel module comprises at least one of proximity module, touch module, light module, tilt module, knob module, and button module;

19. The non-transitory computer readable medium according to claim 18, wherein the at least one animate module is selected from a group consisting of rotator module, angular module, and plugger module.

20. The non-transitory computer readable medium according to claim 18, wherein the project can contain multiple processes that can be run simultaneously by the CU.
